(19) United States
(12) Patent Application Publication
(10) Pub. No.: US 2020/0031154 A1
(43) Pub. Date: Jan. 30, 2020

(54) APPLYING FIXING LIQUID TO PRINT MEDIA

(71) Applicant: HEWLETT-PACKARD DEVELOPMENT COMPANY, L.P., Spring, TX (US)

(72) Inventors: Macia SOLE PONS, Corvallis, OR (US); Marta BLANCH, Sant Cugat del Valles (ES); Eduardo AMELA CONESA, Sant Cugat del Valles (ES)

(21) Appl. No.: 16/479,506

(22) PCT Filed: Apr. 21, 2017
(86) PCT No.: PCT/US2017/028946

§ 371 Date: Jul. 19, 2019

(51) Int. Cl. B41M 7/00

(52) U.S. Cl. CPC B41M 7/0018

(57) ABSTRACT

A printing method is disclosed, in which a fixing liquid is applied to a print medium both to first regions of the print medium that are to be printed and to second regions of the print medium that are not to be printed. A printing liquid is also applied to the print medium at the first regions of the print medium. The fixing liquid applied to the second regions of the print medium protects the second regions of the print medium from aerosol droplets generated when applying the printing liquid to the first regions of the print medium.

### BACKGROUND

Some printing systems form a printed image by ejecting printing liquid from printing liquid printheads. Thereby, printing liquid is applied onto a print medium for printing a pattern of individual dots at particular locations. The printed pattern reproduces an image on the print medium. At least some of these printing systems are commonly referred to as inkjet printers.

### BRIEF DESCRIPTION OF THE DRAWINGS

Various examples will be described below by referring to the following figures:

FIG. 1 shows a print medium with printed areas and non-printed areas, with electrostatic image defects visible in the non-printed areas according to an example;

FIG. 2 shows a triboelectric series of example print media substrates;

FIG. 3 is a schematic view of a printing system according to an example;

FIG. 4 is a block diagram of a printing system according to an example;

FIG. 5 is a schematic diagram showing a printing method according to an example; and

FIG. 6 shows a print medium printed according to an example.

### DETAILED DESCRIPTION

Before the method, system and related aspects of the disclosure are described, it is to be understood that this disclosure is not restricted to the particular process features and materials disclosed herein because such process features and materials may vary. It is also to be understood that the terminology used herein is used for the purpose of describing particular examples. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

In the following description, numerous details are set forth to provide an understanding of the examples disclosed herein. However, it will be understood by those skilled in the art that the examples may be practiced without these details. Further, in the following detailed description, reference is made to the accompanying drawings, in which various examples are shown by way of illustration. In this regard, directional terminology, such as “top,” “bottom,” “front,” “back,” “left,” “right,” “vertical,”, etc., is used with reference to the orientation of the Figure(s) being described. Because disclosed components can be positioned in a number of different orientations, the directional terminology is used for purposes of illustration and is in no way limiting.

As used in this disclosure, a plurality of items, structural elements, compositional elements, and/or materials may be presented in a common list for convenience. However, these lists should be consumed as though each member of the list is individually identified as a separate and unique member. Thus, no individual member of such list should be construed as a de facto equivalent of any other member of the same list solely based on their presentation in a common group without indications to the contrary.

Unless otherwise stated, any feature described herein can be combined with any aspect or any other feature described herein.

Printing techniques in which a printing liquid is applied by firing small drops of the printing liquid from a printhead onto a print medium substrate can additionally generate undesirable, much smaller, droplets of printing liquid. These smaller droplets are known as aerosol droplets. Aerosol droplets are often electrically charged and, due to their small mass, can be deviated from a desired trajectory from the printhead to the print medium, especially when the print medium itself is electrostatically charged. Print media can become electrostatically charged in many ways, for example as a result of rubbing when loading the print media into a printer, by friction while being removed from a substrate pile, or as a result of removing any protective layer that may be present on the print medium for storage and transport, and that is removed prior to printing.

Due to the electrostatic charge of the print medium, and/or the electrical charge of the aerosol droplets, the aerosol droplets can end up deposited on parts of the print medium away from the target area. This is especially troublesome for non-printed areas of the print medium, since the aerosol droplets will be most visible in these areas, leading to print defects known as electrostatic image quality defects.

A fixing liquid may be used for facilitating print quality of a printed pattern. For example, a fixing liquid may be used for addressing coalescence, bleed, feathering, or similar effects characterized by printing liquid or pigment migration across a printed surface. Methods for applying a fixing liquid include roll coating, spray coating, manual application and ejection. Ejection of fixing liquid is often implemented using a treatment printhead. The fixing liquid may be applied before, after or, quasi-simultaneously to the application of printing liquid on a print medium. A fixing liquid to be applied before application is also referred to as a pretreatment liquid.

Fixing liquid is applied just to regions of the print medium that are also printed with printing liquid. This is because it is considered that the fixing liquid is only of benefit when combined with the printing liquid, for example serving to neutralise electrical charge on printing liquid particles and controlling coalescence.

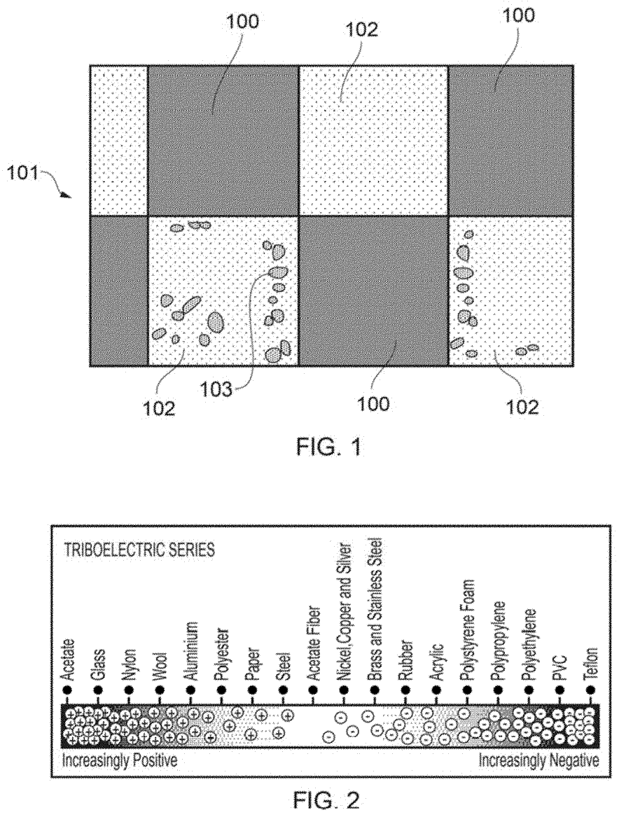

FIG. 1 shows an example of chequerboard pattern of black squares 100 printed on a print medium 101. Unprinted areas in the form of white squares 102 are located between the black squares 100. Electrostatic print qualify defects 103 due to aerosol droplets landing on unprinted areas of the print medium 101 are clearly visible.

One technique for dealing with aerosol droplets involves applying a suction in the region of the printheads in order to extract air from the gap between the printheads and the print media. Other techniques seek to reduce electrostatic charge on the print medium by using an ionizer bar located in a print medium input or on a print carriage, or pre-processing the print medium with an ionizing air gun. Some of these techniques utilize additional hardware components and are not easily adaptable to different levels of electrostatic charge, for example due to different types of print media. Another technique involves hand-wiping the media with an antistatic liquid prior to printing.

For example, FIG. 2 shows a triboelectric series of different types of print media, ranging from acetate on the far left, through glass, nylon, wool, aluminium, polyester, paper, steel, acetate fibre, nickel or copper or silver, brass or stainless steel, rubber, acrylic, polystyrene foam, polypropylene, polyurethane, polyvinyl chloride (PVC) to Teflon® on the far right, showing how different materials tend to support different amounts and polarities of electrostatic charge as a result of rubbing. It will be understood that the triboelectric series shown in FIG. 2 is intended only to illustrate that different materials tend to present different electrostatic charges, and is not intended as a definitive or limiting list of suitable print media.

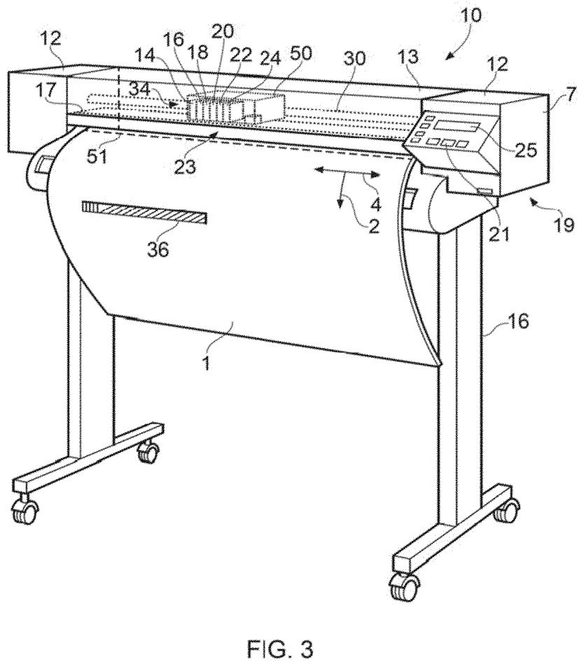

FIG. 3 shows a schematic view of a printing system 10 according to an example. Printing system 10 is exemplified as an industrial printer, i.e., a printer designed for use in: a) manufacturing, b) production lines, and/or c) large scale printing (both size and production) printing. Printing system 10 may be, for example, an inkjet printer. It will be understood that a printing system as used herein is not limited to an industrial printer, but also may include other types of printing systems such as, but not limited to, printers for printing small/average size printing media (e.g.. desktop printers or portable printers).

Printing system 10 includes a housing 12 enclosing a chassis (not shown) forming a print assembly 7. Print assembly 7 is supported by a leg assembly 16. It will be understood that print assembly 7 may be designed to be supported by a desktop during operation. A print media transport assembly 17 feeds a print medium 1 through a print zone 23 and advances print medium 1 in a media advance direction 2. Printing system 10 includes a user terminal 19 for receiving user inputs through, e.g., a keypad 21, and providing visual feedback to the user through, e.g., a display 25. It will be understood that user interaction may be implemented by other suitable means such as a personal computer operatively connected to printing system 10.

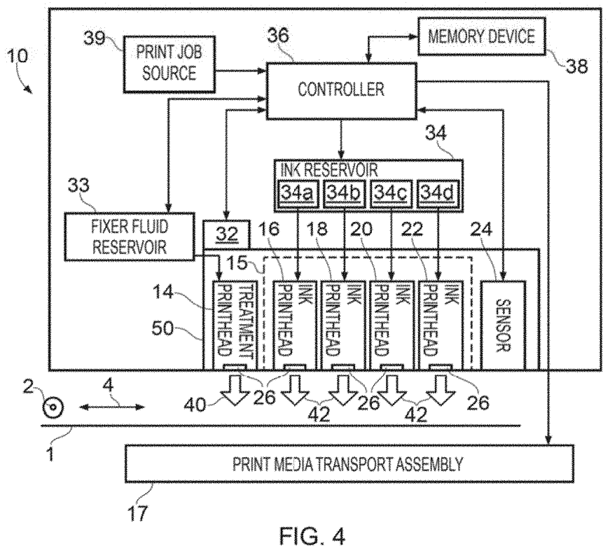

A carriage 50 is slidably mounted on a guide rod 30. Guide rod 30 defines a carriage transition axis 51 along which carnage 50 traverses over print zone 23 for performing printing. A carriage drive 32 (shown in FIG. 4) actuates carnage 50 for effecting the carriage transition. Thereby, carriage 50 is reciprocally translatable in a transition direction 4, which may be a forward direction (e.g., left-to-right) and a backward direction (e.g., right-to-left), over print zone 23. Carriage 50 and guide rod 30 are enclosed by a hood 13.

Carriage 50 includes positions for receiving respective printheads therein. As used herein, a printhead is a device including a nozzle or a group of nozzles through which drops of a liquid (e.g., a fixing liquid or a printing liquid) can be ejected. Printhead assembly 34 is operated (or ejecting printing liquid and fixing liquid so as to print a printing pattern 36 on print medium 1. As used herein, “printing liquid” refers to a solution composition that includes a liquid vehicle and a colorant or filter for reproducing an image on a print medium. As used herein, “fixing liquid” refers to a solution composition used in a printing system for improving print quality. A fixing liquid may function by, for example, (i) electrically neutralizing charged colorant particles to allow the particles to agglomerate, (ii) chemically reacting with colorant in a print medium (e.g., a gloss enhancer) and/or (iii) physically reading with the colorant (e.g., a durability enhancer coating using polymers). This list is not exhaustive, and other attributes may also be present.

In the example illustrated in FIG. 3, carriage 50 includes five positions for a printhead assembly 34: one position is for a fixing liquid printhead and four positions are for printing liquid printheads. Further examples of configurations of carriage 50 are illustrated below in a non-limiting manner. Printing liquid printheads 16, 18, 20, 22 are configured for ejecting printing liquid through one or more nozzles over a print area; fixing liquid printhead 14 is configured to eject fixing liquid for treating the print area. Carriage 50 may also include a sensor 24 for estimating alignment of a printhead, for sensing a printed region or for determining a type of print medium.

FIG. 4 is a block diagram of the printing system 10 of FIG. 3. In the illustrated example, carriage 50 supports four printing liquid printheads 16, 18, 20, 22 (which constitute a printing liquid printhead assembly 15), a fixing liquid printhead 14, and sensor 24. Further, printing system 10 includes a print media transport assembly 17, on which print medium 1 is supported and advanced in a media advance direction 2, which is perpendicular to the plane of the Figure. A controller 36 is configured for being operatively connected to the above elements of printing system 10 as well as a fixing liquid reservoir 33, a printing liquid reservoir 34, a memory device 38, and a print job source 39.

As used herein, a printhead is a device including a nozzle or nozzles 26 through which drops of a liquid (e.g., a fixing liquid 40 or a printing liquid 42) can be ejected. The particular liquid ejection mechanism within the printhead may take on a variety of different forms such as, but not limited to, those using piezo-electric or thermal printhead technology. Nozzles 26 may be arranged in different manners. Each printhead may include multiple rows of nozzles arranged along media advance direction 2. The length of the rows of nozzles along the media advance direction defines a print swath. The width of this band along media advance direction 2 is referred to as the “swath width”, which defines the extent of a pattern of printing liquid or fixing liquid which can be laid down in a single transition of carnage 50.

Each of printing liquid printheads 16, 18, 20, 22 is configured to eject printing liquid 42 of a different colour (referred to as base colours). Printing liquid printheads 16, 18, 20, 22 are fluidly connected to printing liquid reservoir 34. Printing liquid reservoir 34 includes separate reservoirs 34a, 34b, 34c, 34d for providing printing liquid to the respective printing liquid printhead. In the illustrated example, separate reservoirs 34a, 34b, 34c, 34d respectively store cyan printing liquid, magenta printing liquid, yellow printing liquid, and black printing liquid. Printing systems commonly employ a plurality of printing liquid printheads to produce secondary colours by combining printing liquid from different printing liquid printheads. Base colours are reproduced on print medium 1 by depositing a drop of the desired colour onto a dot location. Secondary or shaded colours are reproduced by depositing drops of different base colours on adjacent dot locations; the human eye interprets the colour mixing as the secondary colour or shading.

A fixing liquid printhead as used herein is a printhead configured to eject fixing liquid for treating an area of a print medium through a nozzle or an array of nozzles 26. The block diagram shows that fixing liquid printhead 14 is fluidly connected to fixing liquid reservoir 33.

Printing liquid reservoir 34 and fixing liquid reservoir 33 include disposable cartridges (not shown). Further, the reservoirs may be mounted on carriage 50 in a position adjacent to the respective printhead. In other configurations (also referred to as off-axis systems), a small liquid supply (printing or fixing) is provided to cartridges (not shown) in carriage 50, each cartridge being associated to a respective printhead; main supplies for printing liquid and fixing liquid are then stored in the respective reservoirs. In an off-axis system, flexible conduits are used to convey the liquid from the off-axis main supplies to the corresponding printhead cartridge. Printheads and reservoirs may be combined into single units, which may be referred to as “pens”.

It will be appreciated that printing system 10 may include any number of printheads suitable for a particular application. In some examples, printing system 10 may include at least one fixing liquid printhead, such as two or more fixing liquid printheads. Printing system 10 may include at least one printing liquid printhead, such as two to six printing liquid printheads, or even more printing liquid printheads. A printhead of printing system 10 may be a disposable printhead or a fixed printhead, which is designed to last for the whole operating life of printing system 10.

The printheads may be arranged in different configurations such as a linear configuration, in which the printheads are aligned along the direction of carriage transition (e.g. transition direction 4). In other examples, the printheads may be arranged in a staggered configuration.

Controller 36 is configured to execute methods described herein. Controller 36 may be implemented, for example, by one or more discrete modules (or data processing components) that are not limited to any particular hardware or machine readable instructions configuration. Controller 36 may be implemented in any computing or data processing environment, including in digital electronic circuitry, e.g., an application-specific integrated circuit, such as a digital signal processor (DSP) or in computer hardware, firmware, device driver, or software (i.e., machine readable instructions). In some implementations, the functionalities of the modules are combined into a single data processing component. In other examples, the respective functionalities of each of one or more of the modules are performed by a respective set of multiple data processing components.

Memory device 38 is accessible by controller 36. Memory device 38 stores process instructions (e.g., machine-readable code, such as computer software) for implementing methods executed by controller 36, as well as data that controller 36 generates or processes such as alignment correction data. Memory device 38 may include one or more tangible machine-readable storage media. Memory devices suitable for embodying these instructions and data include all forms of computer-readable memory, including, for example, semiconductor memory devices, such as EPROM, EEPROM, and flash memory devices, magnetic disks such as internal hard disks and removable hard disks, magneto-optical disks, and ROM/RAM devices or other non-transitory storage.

Controller 36 receives print job commands and data from print job source 39, which may be a computer source or other source of print jobs, in order to print an image. Controller 36 may determine a print mask from the received data. A print mask refers to logic that includes control data determining which nozzles 26 of different printheads 14, 16, 20, 22 are fired at a given time to eject liquid in order to reproduce the print job on print medium 1. The print mask may be stored in memory device 38. Controller 36 is operatively connected to fixing liquid printhead 14, printing liquid printhead assembly 15 and the respective reservoirs to control ejection of printing liquid 42 and fixing liquid 40 according to the print mask.

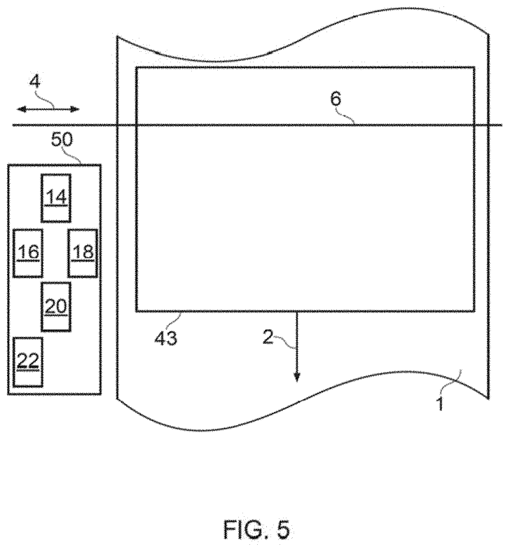

Controller 36 acts according to the print mask to provide motion control signals to (i) print media transport assembly 17 to advance print medium 1 in media advance direction 2, and (ii) carriage drive 32 to traverse carriage 50 across print medium 1 in transition direction 4 (e.g., along a scan axis 6 as shown in FIG. 5). Controller 36 may generate the motion control signals in consideration of estimated printhead misalignments, for example by using calibration data stored in memory device 38. Controller 36 may be operatively connected to sensor 24 to automatically determine a type of print medium 1 being used, or to detect and distinguish between printed areas and non-printed areas. Further, in operation for printing, controller 36 provides firing signals to nozzles 26 in the respective printheads in order to eject printing liquid and/or fixing liquid at particular locations on print medium 1 during transition of carriage 50 over print medium 1 according to a determined print mask. Controller 36 may selectively fire selected nozzles from a nozzle array of a printhead for accurately applying fixing liquid or printing liquid to individual dots in a print area.

A printer such as printing system 10 can be operated according to several different print modes. For example, in a single-pass print mode, after each printing pass the print medium is advanced a distance equal to the full span of a nozzle array (i.e., a swath width), such that each pass forms a complete strip of an image on the print medium. In a multi-pass print mode, the print medium advances a fraction of the total length of a nozzle array after each printing pass of the printheads, and each strip of the image to be printed is formed in successive passes of the printheads. Further, printing can be unidirectional where the printheads print when travelling just in one direction along the scan axis of carriage 50. Printing can be bidirectional where the printheads print when travelling in a “forward pass” and also when travelling in a “return pass,” the print medium being advanced after each pass.

In the following, operation of printing system 10 in a bidirectional printing mode for reproducing an image in an image print area 43 according to a particular print job is illustrated. In the example, printheads 14, 16, 18, 20, 22 are arranged in a staggered configuration as illustrated in FIG. 5. As print medium 1 is advanced in media advance direction 2, the bottom edge of image print area 43 first encounters nozzles of fixing liquid printhead 14. In a first pass of carriage 50 over an image print area 43 in a forward direction (e.g., left-to right) controller 36 will selectively fire nozzles of fixing liquid printhead 14 to apply fixing liquid along a swath width over a first portion of image print area 43 according to a print mask. After a first pass, print medium 1 is incrementally advanced by an advance distance. A fresh second portion of image print area 43 is positioned below fixing liquid printhead 14; the first portion, already treated with fixing liquid, is now below printing liquid printheads 16, 18.

During a second pass of carriage 50 in a reverse direction (e.g., right-to-left) fixing liquid printhead 14 and selected printing liquid printheads are operated for applying fixing liquid over the second portion and printing liquid over the first portion according to the particular print mask. Upon completion of a second pass, print medium 1 is advanced the same incremental distance such that a fresh third portion of image print area 43 is positioned below fixing liquid printhead 14, the second portion, already treated with fixing liquid, is now below printing liquid printheads 16, 18; the first portion, already treated with fixing liquid and printed with printing liquid from printing liquid printheads 16, 18, is now below printing liquid printhead 20. Then, carriage 50 traverses again over image print area 43 while selectively operating fixing liquid printhead 14 and printing liquid printheads 16, 18, 20 to apply fixing liquid and printing liquid according to the particular print mask. In subsequent passes, printing system 10 operates analogously in order to reproduce a desired image on print medium 1.

It is to be noted that, in existing printing systems, fixing liquid is applied to the print medium just in areas that are subsequently to be printed with printing liquid. This is because fixing liquid, when applied as a pretreatment, has been applied to the print medium for the purpose of helping pigment particles in the printing liquid to agglomerate at print locations on the print medium at which they have been fired by the printheads.

It has surprisingly been found that applying fixing liquid to non-printed areas of the print medium is remarkably effective at protecting the non-printed areas from aerosol droplets generated during the printing process.

In one example, a printing method comprises applying a fixing liquid to a print medium, the fixing liquid being applied both to first regions of the print medium that are to be printed and to second regions of the print medium that are not to be printed. Printing liquid is applied to the print medium, the printing liquid being applied to the first regions of the print medium. The fixing liquid applied to the second regions of the print medium protects the second regions of the print medium from aerosol droplets generated when applying the printing liquid to the first regions of the print medium.

The fixing liquid may act as a barrier between the print medium and the aerosol droplets. Where the print medium is electrostatically charged, the fixing liquid may act to dissipate the electrostatic charge, and thus reduce any electrostatic attraction between the aerosol droplets and the print medium. The dissipation of electrostatic charge may be due to charged particles in the fixing liquid, for example cationic polymers, at least partially cancelling the electrostatic charge on the print medium. Alternatively or in addition, the dissipation of electrostatic charge may be due to the fixing liquid being electrically conductive. Many fixing liquids comprise an aqueous solution, for example an aqueous polymer solution, and the aqueous component of the solution is electrically conductive, thus helping to dissipate electrostatic charge. The process of applying fixing liquid by way of fixing liquid printhead 14 may also tend to raise the relative humidity of air in the print zone 23, making the air more electrically conductive, and this can help to reduce electrostatic charge on the print medium 1.

In some examples, the first regions together define a print area on the print medium, and fixing liquid is applied to second regions within the print area. In some examples, fixing liquid is not applied to regions outside the print area. In examples where a print area does not extend over substantially all of the print medium, for instance when printing an image only in the centre of a sheet of print medium, there is a reduced risk of aerosol droplet deposition on areas of the print medium away from the print area. This may be because the carriage 50 does not traverse those areas away from the print area, and also because the printheads are not generally activated over areas away from the print area. Accordingly, aerosol droplets tend not to be generated over the areas away from the print area, which means that application of fixing liquid to those areas could be superfluous. However, in other examples, the carriage 50 may traverse over the whole width of the print medium before the print medium is advanced an incremental distance, even if the print area is not as wide as the print medium. In these examples, it may be useful to apply fixing liquid outside the print area since aerosol may still be present in or over the print zone 23 even when the carriage 50 is not above the print area.

In some examples, the print mask determines which areas are to be printed and which areas are not to be printed, and this allows the controller 36 to control the fixing liquid printhead and printing liquid printheads as required. In some examples, sensor 24 may be an optical sensor to detect and distinguish between printed areas and non-printed areas.

In some examples, an identification of a type of print medium may be determined, and an areal density of fixing liquid applied to the second regions may be set according to the type of print medium. The determination may be made by a user, for example by adjusting a setting on the printing system 10 according to a substrate material of the print medium. In other examples, the determination may be made automatically, for instance by way of sensor 24 being a material type sensor or electrostatic charge sensor. This allows the printing system 10 to apply different appropriate areal densities of fixing liquid to the second regions depending on the material of which the printing medium is made. With reference to the triboelectric series shown in FIG. 2, it can be seen that print media made of polyvinyl chloride or nylon, for example, will tend to become more electrostatically charged than print media made of acetate fibre, and may therefore benefit from application of a higher areal density of fixing liquid to the second regions in order to help reduce the electrostatic charge. Moreover, any given type of print medium may be more or less electrostatically charged depending on previous handling and media loading workflow, as well as environmental conditions such as humidity. It is therefore useful for the printing system 10 to allow the areal density of fixing liquid applied to the second regions (as well as to the first regions) to be adjusted so as to take into account these variations. Indeed, there may be instances in which the application of fixing liquid to non-printed regions is not needed, in which case the printing system 10 can be set so as not to apply fixing liquid to those regions.

In some examples, a substantially constant areal density of fixing liquid is applied to the second areas for a given type of print medium. Different areal densities of fixing liquid may be applied to the first areas depending on the areal density of printing liquid that is applied by the printing liquid printheads.

In some examples, the fixing liquid may be an aqueous polymer solution, and may for instance be an aqueous cationic polymer solution. Fixing liquids in the form of aqueous solutions tend to be electrically conductive. In some examples, the fixing liquid is more electrically conductive than the printing liquid.

The fixing liquid of some examples may be substantially transparent, or at least may dry or cure to a substantially transparent state. In these examples, the fixing liquid will not alter the colour of the print medium in non-printed regions thereof.

In other examples, a printing system for printing a print medium comprises a controller to control a fixing liquid printhead assembly so as to apply a fixing liquid to the print medium. The controller may also be to control a printing liquid printhead assembly so as to apply printing liquid to predetermined print regions of the print medium. The controller may be to control the fixing liquid printhead assembly to apply the fixing liquid to the print medium to regions other than the predetermined print regions as well as to the predetermined print regions. The fixing liquid can be applied to the regions other than the predetermined print regions and can be to protect the print medium from printing liquid aerosol droplets.

In some examples, the controller may be to determine a print area containing the print regions on the print medium. The controller may also be to control the fixing liquid printhead assembly so as to apply the fixing liquid to the print medium to regions other than the predetermined print regions within the print area. In some examples, the controller may be to control the fixing liquid printhead so as not to apply fixing liquid to regions outside the print area.

In some examples, the controller may be to control an areal density of fixing liquid applied to the print medium by the fixing liquid printhead. For instance, the controller may be to control the areal density of fixing liquid applied to the print medium in regions other than the predetermined print regions according to a type of the print medium. A sensor may be provided to detect the type of the print medium.

In some examples, the controller may be to control the fixing liquid printhead to apply a substantially constant areal density of fixing liquid to the regions other than the predetermined print regions for a given type of print medium.

In addition, some examples provide a non-transitory machine readable storage medium storing instructions that, when executed, operate a printing system to: apply a fixing liquid to a print medium, the fixing liquid being applied both to first regions of the print medium that are to be printed and to second regions of the print medium that are not to be printed; and apply a printing liquid to the print medium, the printing liquid being applied to the first regions of the print medium; wherein the fixing liquid applied to the second regions of the print medium protects the second regions of the print medium from aerosol droplets generated when applying the printing liquid to the first regions of the print medium.

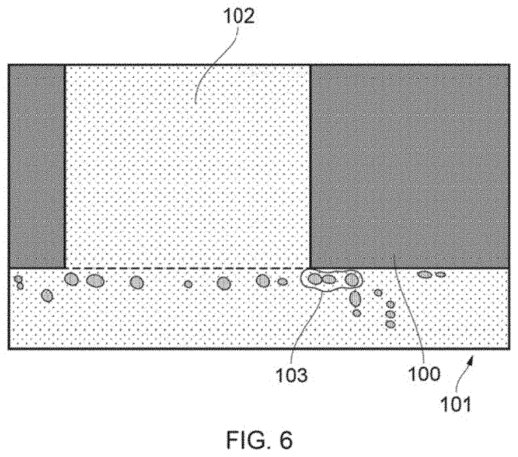

FIG. 6 shows an example of chequerboard pattern of black squares 100 printed on a print medium 101. Unprinted areas in the form of white squares 102 are located between the black squares 100. Electrostatic print quality defects 103 due to aerosol droplets landing on unprinted areas of the print medium 101 are visible on regions of the print medium 101 to which fixing liquid has not been applied. However, it can clearly be seen that electrostatic print quality defects are largely absent from the white squares 102 to which fixing liquid has been applied by way of the method and printing system described above.

Certain examples can be implemented on existing printing systems 10 simply by reprogramming the controller 36 so as to cause fixing liquid to be applied, by the fixing liquid printhead 14, to the second regions of the print medium 1 that are not to be printed with printing liquid as well as to the first regions of the print medium 1 that are to be printed with printing liquid. In some examples, no additional hardware or manual pre-processing is required.

1. A printing method, comprising:
applying a fixing liquid to a print medium, the fixing liquid being applied both to first regions of the print medium that are to be printed and to second regions of the print medium that are not to be printed; and
applying a printing liquid to the print medium, the printing liquid being applied to the first regions of the print medium.

2. The method of claim 1, wherein the first regions together define a print area on the print medium, and wherein fixing liquid is applied to second regions within the print area.

3. The method of claim 2, wherein fixing liquid is not applied to regions outside the print area.

4. The method of claim 1, wherein an identification of a type of print medium is determined, and an areal density of fixing liquid applied to the second regions is set according to the type of print medium.

5. The method of claim 1, wherein a substantially constant areal density of fixing liquid is applied to the second areas for a given type of print medium.

6. The method of claim 1, wherein the fixing liquid is an aqueous polymer solution.

7. The method of claim 1, wherein the fixing liquid is an aqueous cationic polymer solution.

8. The method of claim 1, wherein the fixing liquid applied to the second regions of the print medium protects the second regions of the print medium from aerosol droplets generated when applying the printing liquid to the first regions of the print medium.

9. A printing system for printing a print medium, comprising:
a controller to:
control a fixing liquid printhead assembly so as to apply a fixing liquid to the print medium; and
control a printing liquid printhead assembly so as to apply printing liquid to predetermined print regions of the print medium;
wherein the controller is to control the fixing liquid printhead assembly to apply the fixing liquid to the print medium to regions other than the predetermined print regions as well as to the predetermined print regions, the fixing liquid applied to the regions other than the predetermined print regions protecting the print medium from printing liquid aerosol droplets.

10. The printing system of claim 9, wherein the controller is to determine a print area containing the print regions on the print medium, and to control the fixing liquid printhead assembly so as to apply the fixing liquid to the print medium to regions other than the predetermined print regions within the print area.

11. The printing system of claim 10, wherein the controller is to control the fixing liquid printhead so as not to apply fixing liquid to regions outside the print area.

12. The printing system of claim 9, wherein the controller is to control an areal density of fixing liquid applied to the print medium by the fixing liquid printhead.

13. The printing system of claim 12, wherein the controller is to control the areal density of fixing liquid applied to the print medium in regions other than the predetermined print regions according to a type of the print medium.

14. The printing system of claim 13, comprising a sensor to detect the type of the print medium.

15. The printing system of claim 12, wherein the controller is to control the fixing liquid printhead to apply a substantially constant areal density of fixing liquid to the regions other than the predetermined print regions for a given type of print medium.

16. A non-transitory machine readable storage medium storing instructions that, when executed, operate a printing system to:
apply a fixing liquid to a print medium, the fixing liquid being applied both to first regions of the print medium that are to be printed and to second regions of the print medium that are not to be printed; and
apply a printing liquid to the print medium, the printing liquid being applied to the first regions of the print medium.
